(19) United States
(12) Patent Application Publication
(10) Pub. No.: US 2003/0177033 A1
(43) Pub. Date: Sep. 18, 2003

(54) Method of internet-based medical record database configuration and system thereof by mutual certification between patient and doctor

(76) Inventors: Yong-Nam Park, Seoul (KR); Han-Ik Cho, Seoul (KR)

Correspondence Address: Diane Dunn McKay, Mathews Collins Shepherd & McKay, Suite 306, 100 Thanet Circle, Princeton, NJ, 08540, US

(21) Appl. No.: 10/258,697

(22) PCT Filed: Apr. 25, 2001
(86) PCT No.: PCT/KR01/00695

(30) Foreign Application Priority Data
Apr. 25, 2000 (KR) 2000/21847

(51) Int. Cl. G06F 17/60; G06F 7/00; G06F 17/00

(52) U.S. Cl. 705/2; 707/104.1

(57) ABSTRACT

An object of the present invention is to provide the electronic medical record including electronic prescription system etc. based on the internet and implementing method thereof which may rapidly and accurately transmit the electronic medical record including prescription etc. of patient treatment issued by doctor to the other doctor or pharmacist of medical facilities or pharmacy, and connect to the advertising system of pharmaceutical company. To accomplish the said objects, the present invention is characterized in that it comprises: the pharmacy database system (14); the group server (18) of the membership pharmaceutical; the Web server (10); the terminal computer group (KIOSK) for payment of medical examination, issuing and transmitting the electronic medical record including slip, prescription etc. according to the result of the medical treatment to the patient-designating medical facilities including pharmacy or the pharmacy in the close vicinity to residence over Internet after the medical treatment of patient; the terminal of the other medical facilities including pharmacy; and the patient certificational database system (16). By noticing that the request and management of such data is implemented in the server on the internet, and in authentication giving access admission, it is hard to identify patient himself, or in the medical characteristics, doctor and patient always has to meet each other, medical facilities play a roll as authentication registration authority (RA) so as to give confirmation to patient identification with generating new patient certificate, and the authenticated patient may have grant right about the designation of new family doctor on the internet later.

### TECHNICAL FIELD

the medical information technology, messenger transmission technology, network technology, electronic authentication technology and internet related technology.

### BACKGROUND OF THE INVENTION

The present invention related to an electronic compulsory medical record database system and its constructing method, which constructs patients database using medical records physicians issue to patients (upon request) in compliance with the medical laws. The proposed database system benefits both the patients and the health-care professions. Patients will be relieved from having to present their medical history on each visit to health care providers. Clinics and pharmacies will be able to shorten service time, improve accuracy and efficiency by having a ready access to accurate patient information including personal and military service data as well as prescription-related information. Under the system for of the specialization of physian and medicine, doctor issues only prescription about drug and pharmacist prepares medicines according to the prescription of doctor. The problems of the system to solve are the standardzation of prescriptional paper, preservation, geographical and time limit by walking delivery, precisional delivery and management etc.

The laws provide patients, who receive care from health care providers, with rights to demand treatment information from attending physicians. Therefore, when requested, physicians must fill out treatment record and issue it to patients.

As a patient changes his/her attending physician, the medical record may become misplaced and/or the patient may not be able to produce his/her medical record. In such events, a rational treatment plan becomes more difficult to implement and treatment may be repeated. As a result, patients may receive excessive and redundant treatment and develop distrust of health care providers.

The same kind of problem can plague the prescription fulfillment service as well. The absence of relevant records on the past drug administration can make an accurate drug dispensation program difficult to implement. In short, the absence of past treatment and prescription information is a weakness to the current health care system by depriving physicians and pharmacists of vital patient information.

The present invention relates to the constitution of the role separation system of pharmacist and doctor in which doctor executes only medical treatment of patient and issues only prescription, and pharmacist executes only preparation and medication, and relates to, in case of giving effect to such a separation system, the electronic prescription system based on the Internet and implementing method thereof which may transmit the treatment prescription of patient issued by doctor to pharmacist of his custom pharmacy rapidly and exactly and may also make use of all medical information as a basis of statistical data of national health by making the said information into database.

Due to the execution of the role separation of pharmacist and doctor, doctor got to issue only prescription about medicine and pharmacist got to prepare and medicate according to the prescription about the medicine. This execution of pharmacist and doctor has an actually urgent problem to solve the standardizing problem of prescription document, document storing problem, geometrical and time limit problem according to the transmission of prescription, exact transmission problem of prescription contents, and management problem.

In order to execute the role separation of pharmacist and doctor successfully, the procedure of medical treatment and preparation should be easier and more convenient for doctor and pharmacist than that of conventional medical treatment and preparation. Thus, if the execution is performed with paper type prescription, rapidity, accuracy and reliability of medication according to the result of treatment may not be guaranteed, mutual and effective medical treatment and remedy between patient, doctor and pharmacist cannot be implemented.

Therefore, in the execution of pharmacist and doctor, it is required to accommodate the sudden change of social environment, and Internet is placed as a representative which may lead such change of social environment in the information age. Since Internet enables the task to be handled with real time, Internet may provide with rapidity and accuracy of the transmission procedure of prescription which emerges as big problem in the role separation of pharmacist and doctor. The constitution of the role separation system of pharmacist and doctor based on the Internet is required and thus making electronic document become also required, and such making electronic document enables doctor to identify patient and issue authentication and enables patient to authenticate for doctor to read his medical record later.

### DISCLOSURE OF THE INVENTION

An object of the present invention is to provide the electronic prescription system based on the Internet and implementing method thereof which may rapidly and accurately transmit the treatment prescription of patient issued by doctor to pharmacist of pharmacy, and also make use of all the medical information related to the medical treatment and medication as a basis of statistical data of the national health by making the said information into database, in case of executing the role separation of pharmacist and doctor, in which doctor implements only treatment of patient and issue only prescription, and pharmacist implements only preparation and medication according to the prescription of doctor.

Another object of the invention is to provide the electronic prescription system based on the Internet and its implementing method which may rationally supply the source of funds required to constitute the electronic prescription system based on the Internet.

And, another object of the invention is to provide the electronic prescription system based on the Internet and its implementing method which has the function to properly reconcile concerns between doctor and pharmacist in the execution of the role separation of pharmacist and doctor.

And, another object of the invention is to provide the electronic prescription system based on the Internet and its implementing method which enables to return profit directly or indirectly to doctor and pharmacist by consuming the advertisement naturally when doctor prescribes and pharmacist confirms the prescription according to the execution of the role separation of pharmacist and doctor, and also enables the advertiser to send the custom advertisement to the target consumer, so that satisfies both sides.

To accomplish the said objects, the present invention is characterized in that it comprises: pharmacy database system storing the geographical and inventory information of the membership pharmacy; group server of the membership pharmaceutical company supplying the said pharmacy with medicines and administering their inventory information as each pharmacy unit; Web server constituting the Internet site for issue and receipt of the electronic prescription on the Internet based on the information of the said pharmacy database system and the said group server of the pharmaceutical company; hospital terminal group issuing and transmitting the electronic prescription according to the result of the medical treatment to the patient designating pharmacy or the pharmacy in the close vicinity to residence over Internet after the medical treatment of patient; the pharmacy terminal group confirming whether the electronic prescription with the corresponding pharmacy registered own number of patient is transmitted in the visit of the patient to the pharmacy, preparing and medicating the medicine according to the prescription order if the said prescription order is received, and transmitting the said medication information to the Web server; and the patient database system collecting the medication information of the said pharmacy terminal and the medical treatment information of hospital terminal group, and storing the general information of each patient.

### BRIEF DESCRIPTION OF THE DRAWINGS

FIG. 1 is the block diagram of the system of the present invention.

FIG. 2 is the flow chart illustrating the procedure of making medical treatment and affair record into database according to the present invention.

FIG. 3 is the flow chart illustrating the procedure of the medical treatment using the medical treatment and affair record, and of updating treatment information according to the present invention.

FIG. 4 is the flow chart illustrating the access to the medical treatment and affair record of patient.

| 1-10: server | 1-11: hospital terminal 1 |
|---|---|
| 1-12: hospital terminal2 | 1-13: pharmacy terminal |
| 1-14: the server of certificate authority about doctor | |
| 1-15: the server of certificate authority about pharmacist | |
| 1-16: patient DB | 1-17: doctor's DB |
| 1-18: pharmacist DB | 1-19: patient |
| 1-20,21: doctor | 1-22: pharmacist |

### DETAILED DESCRIPTION OF THE PREFERRED EMBODIMENTS

Referring to the attached drawing, the present invention may be explained more particularly as below.

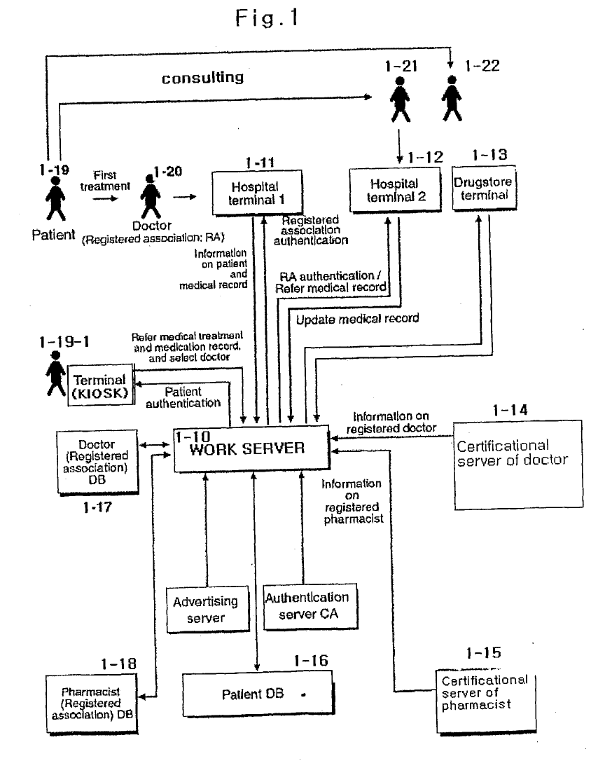

FIG. 1 is the block diagram illustrating the constituting system of the medical treatment and affair record database based on the Internet.

As referred herein, the system of the present invention may comprises the server (1-10) constituting and managing the homepage for electronic prescription ordering on the Internet.

The Internet site managed by this server (1-10) may be connected with all the hospital terminal (1-11,12) and pharmacy terminal (1-13) of whole country, and then whenever needed, the treatment information of registered patient may be obtained form the said server (1-10) and the patient registration and renewal information of the treatment record may be updated.

The said server (1-10) may be connected with the patient database (1-16) storing the first or new medical treatment and affair record of specific patient transmitted from the above all pharmacy terminals (1-13) or hospital terminals (1-11,12).

And, the said server (1-10) may be connected with medical association server (1-14) and pharmaceutical association server (1-15), and then the registered doctor and pharmacist information provided from these associations may be downloaded, and such downloaded new pharmacist and doctor registration numbers are stored in each pharmacist database (1-18) and doctor database (1-17).

When patient (1-19) visits hospital and requests the medical treatment of doctor (1-20), doctor treats the patient and prescribes according to the result of the treatment.

The medication about the prescription may be implemented in the pharmacy according to the role separation of pharmacist and doctor.

At this time, since doctor has a duty to provide patient with the treatment record, in the request of the patient, doctor has to surely write out and provide with the medical treatment and affair record, and may transmit the patient record written down by doctor to the server (1-10) using hospital terminal (1-11) under the agreement of patient.

Before such transmission of the treatment record by doctor, the authentication over patient enables doctor to play a role of a registration authority.

The authentication of a patient is very important process to maintain genuineness and reliability of patient database.

Server (1-10) may be connected with medical association server (1-14) and pharmaceutical association server (1-15), and downloads the registered doctor and pharmacist information from each association and stores in each pharmacist database (1-18) and doctor database (1-17) of the server, and whenever each of doctor (1-20,21) of hospital terminal (1-11,12) or pharmacist (1-22) of pharmacy terminal (1-13) requests authentication as the registration authority, the server refers and authenticate.

Therefore, when the corresponding treatment doctor requests the authentication of registration authority in order to register the treatment record about the specific patient from hospital terminal (1-11), this authentication is referred and approved, and then doctor transmits the said record to server (1-10).

When the treatment record is inputted from hospital terminal (1-11), server (1-10) stores the record in patient database (1-16).

Patient database (1-16) is stored and managed individually, and after the first patient database is created, all the next treatment record or medication record is accumulatively recorded to the account of the membership patient.

Therefore, even though patient changes into other hospital or family doctor, new family doctor may read the past treatment record recorded to database of the patient using the corresponding hospital terminal (1-12) so that may avoid repeated treatment and examination.

Likewise, at this time doctor transmits the result of patient so that the disease history of patient may be administered continuously and systematically.

And, it is also allowed to refer to the past disease history or treatment result etc. of the visited patient using pharmacy terminal (1-13) in pharmacy, at this time the medication information is written out and uploaded by pharmacist of as registration authority.

Since the upload of the medication information by pharmacist and the treatment record by doctor burdens with duty or provides with certain economic value, early accomplishment of constituting aim of database of each patient may be promoted by compensation. And it may be used as statistic data of the public health.

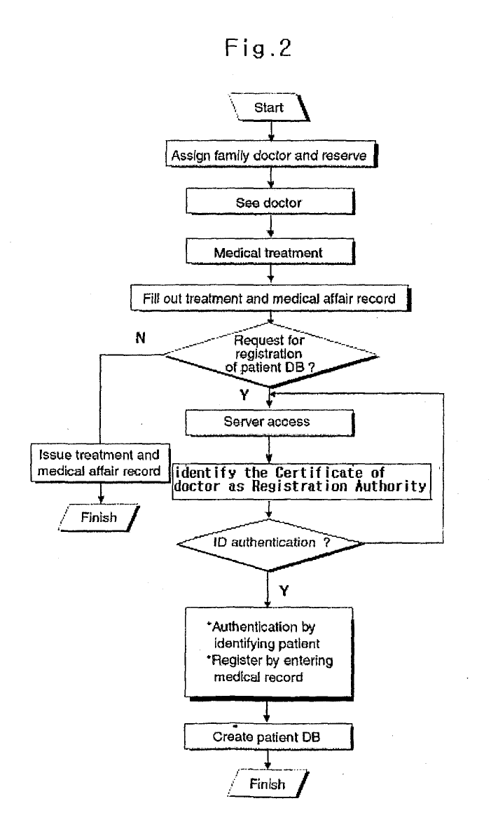

FIG. 2 is the flow chart illustrating the procedure of making patient database. As referred herein, when patient selects the family doctor and makes reservation through Internet etc., then visits hospital, the medical treatment is executed by the corresponding reserved family doctor. The doctor has to write out and provide the medical treatment and affair record to patient, but it is difficult for all patients to administer the record systematically. Therefore, the family doctor refers to whether the patient whom the doctor treats is registered to patient database, so that if the patient is registered, the doctor transmits the treatment record to patient database through the server, and if the patient is unregistered, doctor confirms whether the patient approves the registration to the patient database.

If the patient refuses to register to patient database, doctor writes out and issues the medical treatment and affair record and then his task is finished.

On the contrary, if the patient admits the registration to patient database, doctor connects hospital terminal to server through Internet and input the doctor's ID so that he obtains the authentication of as the registration authority, and then transmits personal data and treatment record of the corresponding patient and creates and registers personal database to the membership patient database.

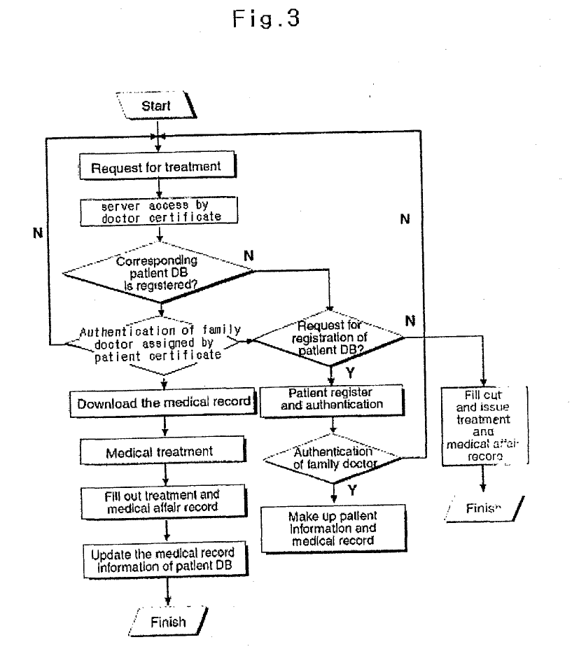

FIG. 3 is the flow chart illustrating the procedure of the medical treatment using the medical treatment and affair record, and of updating treatment information according to the present invention. Doctor assigned by patient connects the patient record database system and input the personal information then searchs the registration or not. If patient already registered, doctor can download the past medical record of patient. Then doctor recognize the information of this patient, and examine the patient medically and write the record of examining result. So doctor also uploads this medical record into the patient medical account. If patient didn't register into the database system, doctor can register the patient with his permission. If he didn't want to register, doctor gives patient the paper form and ends the medical examine.

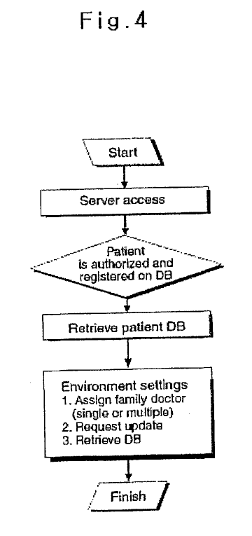

FIG. 4 is the flow chart illustrating the access to the medical treatment and affair record of patient. In this way, patient can retrieve his own medical record with his certificate. Patient has access to the medical database server and retrieve his medical record. Then he can reassign the family doctor and pharmacist with his certificate and their digital key and upload the additional information of new member.

### BEST MODE FOR CARRYING OUT THE INVENTION

We believe that hospitals, pharmacies, the government, and the pharmaceutical industry must take an active part because the proposed system benefits all stakeholders of the national health care by transmitting the prescriptions accurately and promptly from physicians to pharmacists and turning treatment and prescription information into a database which provides basic statistics for the national health care. The funding of the Internet-based prescription system must be allocated proportionately on the basis of the benefits received by each stakeholder. In implementing the proposed division of health care delivery, hospitals and pharmacies must discharge health care activities wisely coordinating the interests of pharmacists, physicians, and patients.

Industrial Availability

An industrial application of the proposed system is the on-line purchase of drugs based on the prescription information. After receiving the prescription, patients can identify the pharmacies able to fill the prescriptions and order the drugs on-line in advance, thus reducing the searching time and waiting time.

What is claimed is

1. a implementing method of constituting the treatment and medical affair record database, wherein the said method includes the mutual authentication between patient and doctor,
the said process of authentication comprises:
a step which doctor and pharmacist treats and interviews a patient;
a step connecting to the server of certificate authority after the treatment and receiving the registration authority (doctor) authentication;
a step determining whether the patient certification database of the corresponding treated patient should be registered after the registration authority authentication in the previous step;
a step which doctor makes and registers the patient certificate including personal information and digital signature of the corresponding patient by digital key for registration as a roll of registration authority if the treated patient is not registered in the previous step;
a step which patient makes singular or multiple selection and authenticates family doctor who has authority reading and adding the treatment and medical affair record (including image data);
a step which doctor registers the treatment and medical affair record as family doctor and, if the patient is a registered patient, updates the existing database with the treatment data of the corresponding time; and
a step which family doctor authenticates authority in which cooperative doctor may read the patient record within the range defined in the medical law in case that the cooperative treatment may be needed with the other doctor.

2. A database constituting system for the treatment and medical affair record as defined in claim 1, wherein the said system includes:
terminal (1-11˜13) installed in hospital and drugstore;
server (1-10) which provides the said hospital and drugstore terminals with the authentication information of as the registration authority, receives and treats the first treatment and medical affair record or update treatment record inputted from each authenticated hospital and drugstore terminal;
patient certification database system (1-16) which stores and updates the treatment record of each patient handled by the said server; and
pharmacist database system (1-18) and doctor database system (1-17) which are connected with the said server and authenticates the qualification of pharmacist and doctor.
